(19) United States
(12) Patent Application Publication
(10) Pub. No.: US 2001/0019028 A1
(43) Pub. Date: Sep. 6, 2001

(54) Paper filter for a device for preparing coffee or tea extracts

(76) Inventors: Rainer Dolfel, Porta Westfalica (DE); Hans-Dieter Olthaus, Minden (DE)

Correspondence Address: VENABLE, BAETJER, HOWARD, and CIVILETTI, LLP, P.O. Box 34385, Washington, DC, 20043-9998, US

(21) Appl. No.: 09/785,664

(22) Filed: Feb. 20, 2001

(30) Foreign Application Priority Data
Feb. 17, 2000 (DE) 200 02 889.8

(51) Int. Cl. B01D 39/18

(52) U.S. Cl. 210/497.3; 210/500.1

(57) ABSTRACT

A generally funnel shaped paper filter for use in a filter device for preparing coffee or tea extracts. The paper filter has a flattened, folded state and an open, unfolded state for use and includes two facing panels joined at lateral sides thereof to define opposite lateral paper filter edges and joined at bottom sides thereof to define a paper filter bottom; an upper edge forming part of each panel and defining a paper filter opening; and an embossed line provided in each panel for stabilizing the paper filter in its open state.

### CROSS-REFERENCE TO RELATED APPLICATION

This application claims the priority of German Utility Model Application No. 200 02 889.8, filed on Feb. 17, 2000, the subject matter of which is incorporated herein by reference.

### BACKGROUND OF THE INVENTION

The present invention relates to a filter device for the preparation of aroma extracts from coffee or tea. The device has a generally funnel-shaped paper filter and a filter receptacle. The paper filter which is generally trapezoidal when flattened, can be inserted into the filter receptacle in an open state, that is, in a condition in which it conforms to the inside space of the filter receptacle.

Filter devices of the above-outlined type are known. The filter receptacle or its utilized inner space of the most widely used filter devices is defined by an approximately frustoconical inner wall face. The paper filter inserts are opened by the user from the flattened condition and are inserted with a nearly exact fit into the inside space of the filter device.

It is a disadvantage of the prior art devices that in the dry condition the paper filter runs the risk of folding inward, particularly when used with coffee makers having pivoting filters. Further, in a wet state the paper filter may fold inward as well or may lie flat.

### SUMMARY OF THE INVENTION

It is therefore an object of the invention to provide a filter device in which the paper filter insert has an improved seating in the filter receptacle and further has a significantly reduced tendency to fold inward in either a dry or a wet condition.

This object and others to become apparent as the specification progresses, are accomplished by the invention, according to which, briefly stated, the generally funnel shaped paper filter for use in a filter device for preparing coffee or tea extracts has a flattened, folded state and an open, unfolded state for use and includes two facing panels joined at lateral sides thereof to define opposite lateral paper filter edges and joined at bottom sides thereof to define a paper filter bottom; an upper edge forming part of each panel and defining a paper filter opening; and an embossed line provided in each panel for stabilizing the paper filter in its open state.

The embossed lines of the paper filter insert make it easier to open the paper filter insert from the flattened position and to generate relatively high restoring forces in the opened condition, so that the paper filter insert is, for all practical purposes, prevented from folding inward even in the dry condition.

### BRIEF DESCRIPTION OF THE DRAWINGS

FIG. 1 is a perspective view of a preferred embodiment of a paper filter insert for a filter device according to the invention, illustrated in a position of use (open position).

FIG. 2 is a top plan view of another preferred embodiment of the paper filter insert, illustrated in the flattened position.

FIG. 2a is a view of the FIG. 2 structure, taken in the direction A.

FIG. 3 is a top plan view of yet another preferred embodiment of the paper filter insert, illustrated in the flattened position.

### DESCRIPTION OF THE PREFERRED EMBODIMENTS

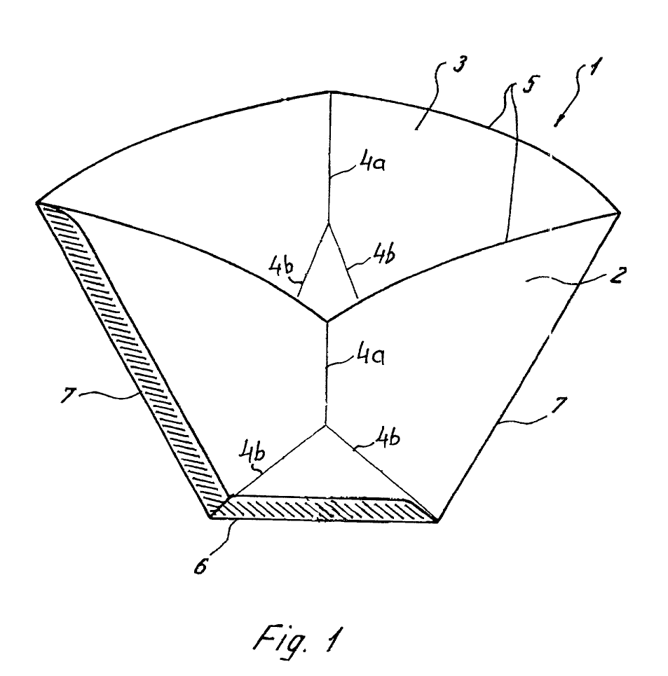

In FIGS. 1-3 the reference numeral 1 generally designates a generally funnel shaped paper filter for insertion in a non-illustrated filter receptacle.

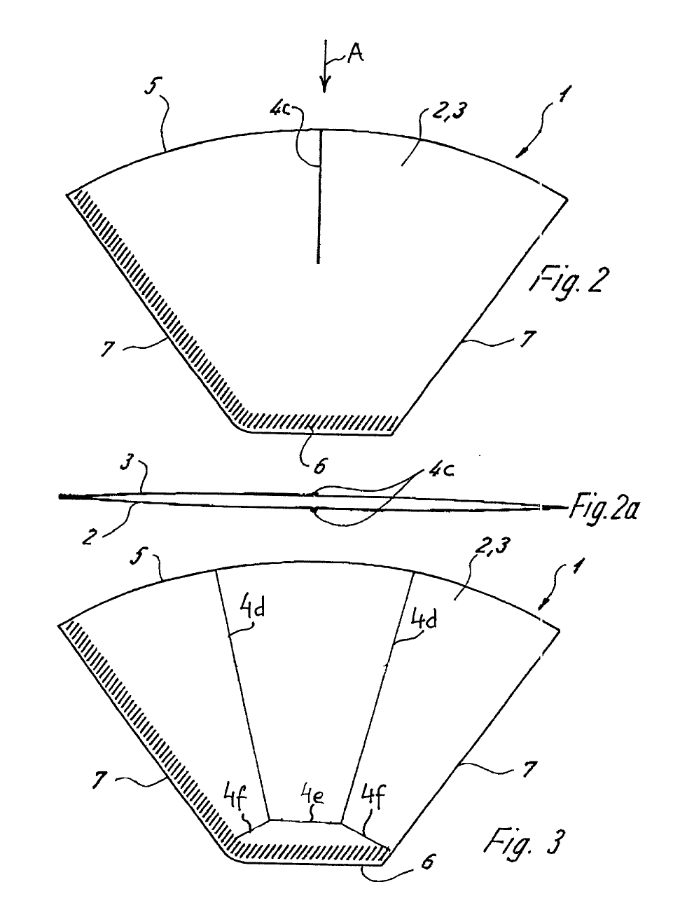

The paper filter inserts 1 have an approximately trapezoidal configuration in the flattened condition, as shown especially in FIGS. 2 and 3.

The paper filter insert 1 has panels 2 and 3 which are superpositioned in a face-to-face orientation in the flattened state, and which, according to the invention, are provided with one or several embossed lines as will be described in detail later. Owing to their restoring forces, the embossed lines serve to stabilize the paper filter insert when in use, that is, in the position in which the paper filter insert is opened up and conforms to the inside space of the filter receptacle.

The embossed lines for the paper filter insert 1 of FIG. 1 are arranged as follows:

Starting from the upper edge 5 of each panel 2 and 3 of the paper filter insert 1, embossed lines 4a extend in the direction of the bottom edge 6 and are joined by embossed lines 4b that extend in the direction of the intersection between the bottom edge 6 and a respective lateral edge 7.

The embodiment according to FIG. 2 is provided only with embossed lines 4c which extend from the upper edge 5 in the direction of the bottom edge 6 and which terminate approximately in the mid region between the upper edge 5 and the bottom edge 6.

In the embodiment of FIG. 3 two embossed lines 4d extend from the upper edge 5 of each panel in the direction of the bottom edge 6. In the vicinity of the bottom edge 6 the ends of the embossed lines 4d are interconnected by an embossed line 4e. Further embossed lines 4f extend bilaterally in the direction of the intersection between the bottom edge 6 and the respective lateral edge 7. The embossed lines 4e and 4f are oriented generally parallel to the upper edge 5.

Similarly to the arrangement in the FIG. 3 embodiment, more than two embossed lines 4d may be provided which start from the upper edge 5 and extend in the direction of the bottom edge 6.

While the various arrangements of the shown and described embossed lines are basically suitable for all conventional filter devices having a frustoconically shaped inside space, the embodiments according to FIGS. 1 and 3 are particularly adapted for filter receptacles with specially configured inside shape. Thus, with the paper filter inserts 1 according to FIGS. 1 and 3 a relatively flat bottom is obtained in the open condition, which results in particularly favorable filtration characteristics.

It will be understood that the above description of the present invention is susceptible to various modifications, changes and adaptations, and the same are intended to be comprehended within the meaning and range of equivalents of the appended claims.

What is claimed is:

1. A generally funnel shaped paper filter for use in a filter device for preparing coffee or tea extracts; said paper filter having a flattened, folded state and an open, unfolded state for use; said paper filter comprising
(a) two facing panels joined at lateral sides thereof to define opposite lateral paper filter edges and joined at bottom sides thereof to define a bottom edge of the paper filter;
(b) an upper edge forming part of each panel and defining a paper filter opening; and
(c) an embossed line provided in each said panel for stabilizing said paper filter in said open state.

2. The paper filter as defined in claim 1, wherein said embossed line extends from said upper edge toward said bottom edge.

3. The paper filter as defined in claim 2, wherein said embossed line is a first embossed line having an end located between said bottom edge and said upper edge; further comprising second embossed lines extending from said end toward opposite corner regions of said paper filter formed by said bottom edge and respective said lateral paper filter edges.

4. The paper filter as defined in claim 2, wherein said embossed line is a first embossed line having a first end located between said bottom edge and said upper edge; further comprising
(a) at least one second embossed line extending from said upper edge toward said bottom edge and having a second end located between said bottom edge and said upper edge and being spaced from said first end;
(b) third embossed lines extending from respective said first and second ends toward opposite corner regions of said paper filter formed by said bottom edge and respective said lateral paper filter edges; and
(c) a fourth embossed line extending from said first end toward said second end.

5. The paper filter as defined in claim 4, wherein said third embossed lines extend generally parallel to said top edge.

6. The paper filter as defined in claim 4, wherein said fourth embossed line extends generally parallel to said top edge.

7. The paper filter as defined in claim 1, wherein said embossed line extends from said upper edge toward said bottom edge and terminates at a distance therefrom.

8. The paper filter as defined in claim 1, wherein said embossed line extends from said upper edge toward said bottom edge and terminates approximately in a mid region between said upper edge and said bottom edge.
